(19) United States
(12) Patent Application Publication
(10) Pub. No.: US 2026/0024338 A1
(43) Pub. Date: Jan. 22, 2026

(54) ROBOT CONTROL APPARATUS AND METHOD THEREOF

(71) Applicants: Hyundai Motor Company, Seoul (KR); Kia Corporation, Seoul (KR)

(72) Inventor: Hyun Soo Ahn, Hwaseong-si (KR)

(21) Appl. No.: 18/958,164

(22) Filed: Nov. 25, 2024

(30) Foreign Application Priority Data
Jul. 19, 2024 (KR) 10-2024-0095878

(51) Int. Cl. G06V 20/50; G06V 10/764; G06V 10/77; G06V 10/82

(52) U.S. Cl. CPC G06V 20/50; G06V 10/764; G06V 10/7715; G06V 10/82

(57) ABSTRACT

A robot control apparatus can include light detection and ranging (LiDAR), a camera, a memory storing a classifier group including a plurality of classifiers and a neural network model, and a processor. The processor can be configured to project a point cloud corresponding to an external object onto a designated surface to obtain a virtual object represented in two dimensions, based on obtaining the point cloud, input a portion of an image obtained by use of the camera, which includes a visual object corresponding to the virtual object, to the neural network model, based on identifying the visual object in the image, and input a designated number of feature maps for the portion of the image to the classifier group to identify whether the external object corresponding to the visual object is a target object, based on obtaining the feature maps.

### CROSS-REFERENCE TO RELATED APPLICATIONS

This application claims the benefit of priority to Korean Patent Application No. 10-2024-0095878, filed in the Korean Intellectual Property Office on Jul. 19, 2024, the entire contents of which are incorporated herein by reference.

### TECHNICAL FIELD

The present disclosure relates to a robot control apparatus and a method thereof.

### BACKGROUND

Recently, research on various robot technologies has been in progress in the field associated with robots. Particularly, various studies for a technology for allowing a robot to follow a target and move have been in progress.

There is a need to accurately identify a target, if the robot follows the target and plans a movement path. To this end, research for identifying the target using various sensors has proceeded.

A camera and LiDAR may be used as various sensors for identifying the target. The camera may obtain two-dimensional (2D) image data, and the LiDAR may obtain space data represented in three dimensions. There is a need to process pieces of data obtained from sensors to follow an object using the camera and the LiDAR.

### SUMMARY

The present disclosure relates to a robot control apparatus and a method thereof, and more particularly, relates to technologies for identifying an external object using a camera and light detection and ranging (LiDAR).

An embodiment of the present disclosure can solve the above-mentioned problems occurring in the prior art while advantages achieved by the prior art are maintained intact.

An embodiment of the present disclosure can provide a robot control apparatus for identifying a target object using a camera and LiDAR, and/or a method thereof.

An embodiment of the present disclosure can provide a robot control apparatus for identifying a target object in real time to provide help to path planning of a robot, and/or a method thereof.

An embodiment of the present disclosure can provide a robot control apparatus for training a classifier using data obtained by a camera and LiDAR to maintain and repair a robot at a relatively low cost, and/or a method thereof.

Technical problems to be solved by an embodiment of the present disclosure are not necessarily limited to the aforementioned problems, and solutions to any other technical problems not mentioned herein can be clearly understood from the following description by those skilled in the art to which the present disclosure pertains.

According to an embodiment of the present disclosure, a robot control apparatus may include light detection and ranging (LiDAR), a camera, a memory storing a classifier group including a plurality of classifiers and a neural network model, and a processor. The processor may project a point cloud corresponding to an external object onto a designated surface to obtain a virtual object represented in two dimensions, based on obtaining the point cloud by use of the LiDAR, may input a portion of an image obtained by use of the camera, the image including a visual object corresponding to the virtual object, to the neural network model, based on identifying the visual object in the image, and may input a designated number of feature maps for the portion of the image to the classifier group to identify whether the external object corresponding to the visual object is a target object, based on obtaining the feature maps from the neural network model.

In an embodiment, the processor may identify whether the external object is the target object, based on a region of interest (ROI) of each of the feature maps input to the classifier group.

In an embodiment, the processor may identify whether the external object is the target object, based on identifying pixel values of the ROI using each of the plurality of classifiers.

In an embodiment, the processor may identify whether the external object is the target object, based on inputting the sum of the pixel values of the ROI to a first Gaussian probability distribution and a second Gaussian probability distribution.

In an embodiment, the processor may identify whether the external object is the target object, based on a first result value output from the first Gaussian probability distribution and a second result value output from the second Gaussian probability distribution.

In an embodiment, the processor may identify that the external object is the target object, based on a difference between a first result value output from the first Gaussian probability distribution and a second result value output from the second Gaussian probability distribution being greater than or equal to a first threshold.

In an embodiment, the processor may postpone determining the external object, based on a difference between a first result value output from the first Gaussian probability distribution and a second result value output from the second Gaussian probability distribution being less than a first threshold and being greater than or equal to a second threshold.

In an embodiment, the processor may identify that the external object is not the target object, based on a difference between a first result value output from the first Gaussian probability distribution and a second result value output from the second Gaussian probability distribution being less than a second threshold, where the second threshold is smaller than a first threshold.

In an embodiment, the processor may train the plurality of classifiers, using a first learning feature map associated with a tracking target and a second learning feature map associated with associated with a general object.

In an embodiment, the processor may obtain the feature maps, based on propagating the portion of the image to a plurality of convolution layers included in the neural network model.

In an embodiment, the processor may initialize at least one of partial classifiers except for a representative classifier among the plurality of classifiers, based on selecting the representative classifier.

In an embodiment, the processor may assign an ROI, based on at least one of the feature maps, while initializing at least one of the plurality of classifiers.

According to an embodiment of the present disclosure, a robot control method may include projecting, by a processor, a point cloud corresponding to an external object onto a designated surface to obtain a virtual object represented in two dimensions, based on obtaining the point cloud by use of light detection and ranging (LiDAR), inputting, by the processor, a portion of an image obtained by use of a camera, the image including a visual object corresponding to the virtual object, to a neural network model stored in a memory, based on identifying the visual object in the image, and inputting, by the processor, a designated number of feature maps for the portion of the image to a classifier group stored in the memory to identify whether the external object corresponding to the visual object is a target object, based on obtaining the feature maps from the neural network model.

A robot control method according to an embodiment may further include identifying whether the external object is the target object, based on a region of interest (ROI) of each of the feature maps input to the classifier group.

A robot control method according to an embodiment may further include identifying whether the external object is the target object, based on identifying pixel values of the ROI using each of a plurality of classifiers included in the classifier group.

A robot control method according to an embodiment may further include identifying whether the external object is the target object, based on inputting the sum of the pixel values of the ROI to a first Gaussian probability distribution and a second Gaussian probability distribution.

A robot control method according to an embodiment may further include identifying whether the external object is the target object, based on a first result value output from the first Gaussian probability distribution and a second result value output from the second Gaussian probability distribution.

A robot control method according to an embodiment may further include identifying that the external object is the target object, based on a difference between a first result value output from the first Gaussian probability distribution and a second result value output from the second Gaussian probability distribution being greater than or equal to a first threshold.

A robot control method according to an embodiment may further include postponing determining the external object, based on a difference between a first result value output from the first Gaussian probability distribution and a second result value output from the second Gaussian probability distribution being less than a first threshold and being greater than or equal to a second threshold.

A robot control method according to an embodiment may further include identifying that the external object is not the target object, based on a difference between a first result value output from the first Gaussian probability distribution and a second result value output from the second Gaussian probability distribution being less than a second threshold, where the second threshold is smaller than a first threshold.

A robot control method according to an embodiment may further include training a plurality of classifiers included in the classifier group, using a first learning feature map associated with a tracking target and a second learning feature map associated with associated with a general object.

A robot control method according to an embodiment may further include obtaining the feature maps, based on propagating the portion of the image to a plurality of convolution layers included in the neural network model.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 illustrates an example of a block diagram associated with a robot control apparatus according to an embodiment of the present disclosure;

FIG. 2 illustrates an example of obtaining feature maps, in an embodiment of the present disclosure;

FIG. 3 illustrates an example associated with a classifier, in an embodiment of the present disclosure;

FIG. 4 illustrates an example of training a classifier, in an embodiment of the present disclosure;

FIG. 5 illustrates an example of determining whether an external object is a target object, in an embodiment of the present disclosure;

FIG. 6 illustrates an example of a flowchart associated with a robot control method according to an embodiment of the present disclosure;

FIG. 7 illustrates an example of a flowchart associated with a robot control method according to an embodiment of the present disclosure; and

FIG. 8 illustrates a computing system associated with a robot control apparatus or a robot control method according to an embodiment of the present disclosure.

### DETAILED DESCRIPTION OF ILLUSTRATIVE EMBODIMENTS

Hereinafter, some example embodiments of the present disclosure will be described in detail with reference to the drawings. In adding the reference numerals to the components of each drawing, identical components can be designated by identical numerals even when they are displayed on different drawings. A detailed description of well-known features or functions can be ruled out to not unnecessarily obscure the gist of the present disclosure.

In describing components of example embodiments of the present disclosure, the terms “first,” “second,” “A,” “B,” “(a),” “(b),” and the like, may be used herein. Such terms can be used merely to distinguish one component from another component, and do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to the contextual meanings in the relevant field of art.

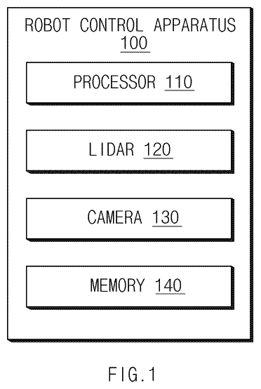

Hereinafter, example embodiments of the present disclosure will be described in detail with reference to FIGS. 1 to 8.

FIG. 1 illustrates an example of a block diagram associated with a robot control apparatus according to an embodiment of the present disclosure.

Referring to FIG. 1, a robot control apparatus 100 according to an embodiment of the present disclosure may be implemented inside and/or outside a robot, and some of the components included in the robot control apparatus 100 may be implemented inside and/or outside the robot. The robot control apparatus 100 may be integrally configured with control units in the robot or may be implemented as a separate device to be connected with the control units of the robot by a separate connection. For example, the robot control apparatus 100 may further include components that are not shown in FIG. 1.

The robot control apparatus 100 according to an embodiment may include a processor 110, light detection and ranging (LiDAR) 120, a camera 130, and a memory 140, any combination of or all of which may be in plural or may include plural components thereof. The processor 110, the LiDAR 120, the camera 130, and the memory 140 may be electronically or operably coupled with each other by an electronic component including a communication bus.

Hereinafter, that pieces of hardware are operably coupled with each other may include that a direct connection or an indirect connection between the pieces of hardware is established wired and/or wirelessly, such that second hardware can be controlled by first hardware among the pieces of hardware.

The different blocks are illustrated, but an embodiment is not limited thereto. Some of the pieces of hardware of FIG. 1 may be included in a single integrated circuit including a system on a chip (SoC), for example. Types of the pieces of hardware included in the robot control apparatus 100 and/or the number of the pieces of hardware are/is not limited to those shown in FIG. 1. For example, the robot control apparatus 100 may include only some of the pieces of hardware shown in FIG. 1.

The robot control apparatus 100 according to an embodiment may include hardware for processing data based on one or more instructions. The hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP), or any combination thereof. The processor 110 may have a structure of a single-core processor or may have a structure of a multi-core processor including a dual core, a quad core, a hexa core, or an octa core, for example.

The robot control apparatus 100 according to an embodiment may include hardware for identifying a distance between an external object and a robot. For example, the hardware for identifying the distance between the external object and the robot may include a depth sensor. For example, the hardware for identifying the distance between the external object and the robot may include at least one of the LiDAR 120, a time of flight (ToF) sensor, a structured light sensor, an ultrasonic sensor, an infrared sensor, or an optical distance sensor, or any combination thereof.

In an embodiment, the LiDAR 120 of the robot control apparatus 100 may obtain datasets for identifying a surrounding thing around the robot control apparatus 100 (or a robot including the robot control apparatus 100). For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding thing to return.

For example, the robot control apparatus 100 may obtain datasets for representing the external object on a space formed by an x-axis, a y-axis, and a z-axis, based on the pulse laser signal reflected from the surrounding thing, by use of the LiDAR 120. For example, the robot control apparatus 100 may obtain datasets including a plurality of points in the space formed by the x-axis, the y-axis, and the z-axis, based on receiving the pulse laser signal at a specified period, by use of the LiDAR 120.

The robot control apparatus 100 according to an embodiment may include the camera 130. For example, the camera 130 may include one or more of optical sensors (e.g., charged coupled device (CCD) sensors and/or complementary metal oxide semiconductor (CMOS) sensors) which generate an electrical signal indicating a color and/or a brightness of light, or any combination thereof. The plurality of optical sensors included in the camera 130 may be arranged in the form of a two-dimensional (2D) array. The camera 130 may obtain electrical signals of the plurality of optical sensors substantially at the same time and may generate an image or frames including a plurality of pixels which correspond to light arriving at the optical sensors in the 2D array and are arranged in two dimensions. For example, photo data captured using the camera 130 may refer to a plurality of images obtained from the camera 130. For example, video data captured using the camera 130 may refer to a sequence of a plurality of images obtained according to a designated frame rate from the camera 130.

The memory 140 of the robot control apparatus 100 according to an embodiment can be a storage medium, which may include hardware for storing data and/or an instruction input and/or output by the processor 110 of the robot control apparatus 100.

For example, the memory 140 may include a volatile memory including a random-access memory (RAM) and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory may include at least one of a programmable ROM (PROM), an erasable PROM (EPROM), an electrically erasable PROM (EEPROM), a flash memory, a hard disk, a compact disc, a solid state drive (SSD), or an embedded multi-media card (eMMC), or any combination thereof.

For example, the memory 140 may include a classifier group including a plurality of classifiers. For example, the memory 140 may include a neural network model. For example, the classifier group including the plurality of classifiers and/or the neural network model may be stored in the memory 140.

In an embodiment, the processor 110 may obtain a point cloud corresponding to the external object by use of the LiDAR 120. For example, the processor 110 may project a point cloud corresponding to the external object onto a designated surface, based on that obtaining the point cloud by use of the LiDAR 120. For example, the designated surface may include an x-y surface on a three-dimensional (3D) space coordinate system formed by an x-axis, a y-axis, and a z-axis. For example, the x-axis may face the front of the robot. For example, the y-axis may face the left of the robot. For example, the z-axis may be perpendicular to the ground.

For example, the processor 110 may project the point cloud corresponding to the external object onto the designated surface to obtain a virtual object represented in two dimensions, based on obtaining the point cloud by use of the LiDAR 120.

For example, the virtual object represented in two dimensions may correspond to the external object. For example, the virtual object represented in two dimensions may be obtained based on performing calibration for the point cloud.

In an embodiment, the processor 110 may obtain an image by use of the camera 130. For example, the processor 110 may identify a visual object corresponding to the virtual object, in the image obtained by use of the camera 130. For example, the visual object may substantially correspond to the external object.

For example, the processor 110 may input a portion of the image obtained by use of the camera 130, which includes the visual object corresponding to the virtual object, to the neural network model, based on identifying the visual object in the image. For example, the neural network model may include a plurality of convolution layers. For example, the neural network model may include a model for obtaining at least one feature map, which is associated with the image.

For example, the neural network model may output the at least one feature map associated with the image, using a convolution channel feature (CCF) scheme.

For example, the processor 110 may obtain feature maps, based on propagating the portion of the image to the plurality of convolution layers included in the neural network model.

In an embodiment, the processor 110 may obtain a designated number of feature maps for the portion of the image from the neural network model. For example, the processor 110 may obtain feature maps output from the neural network model. For example, the processor 110 may input the designated number of feature maps for the portion of the image to the classifier group, based on obtaining the feature maps from the neural network model.

For example, the classifier group may include the plurality of classifiers. For example, each of the plurality of classifiers may include a first Gaussian probability distribution and a second Gaussian probability distribution. For example, the processor 110 may train the plurality of classifiers, using a first learning feature map associated with a tracking target and/or a second learning feature map associated with a general object. For example, the processor 110 may train the first Gaussian probability distribution using the first learning feature map associated with the tracking target. For example, the processor 110 may train the second Gaussian probability distribution using the second learning feature map associated with the general object.

In an embodiment, the processor 110 may input the obtained feature maps to the classifier group to identify whether the external object corresponding to the visual object is a target object, based on obtaining the designated number of feature maps for the portion of the image from the neural network model.

For example, the target object may be selected by a user. For example, the target object may be selected through a screen displayed on a display (not shown) included in the robot control apparatus 100. For example, the robot control apparatus 100 may set the external object, which performs a designated gesture, to the target object, based on identifying the designated gesture of the external object.

For example, the processor 110 may identify a region of interest (ROI) of each of the feature maps input to the classifier group. For example, the processor 110 may input the ROI of each of the feature maps input to the classifier group to each of the plurality of classifiers. For example, the processor 110 may input the ROI to the plurality of classifiers to identify whether the external object is the target object, based on identifying the ROI of each of the feature maps input to the classifier group.

For example, the processor 110 may identify pixel values of the ROI using each of the plurality of classifiers. For example, the processor 110 may identify whether the external object is the target object, based on identifying the pixel value of the ROI using each of the plurality of classifiers.

For example, the processor 110 may identify pixel values of the ROI. For example, the pixel values of the ROI may include at least one of the sum of the pixel values included in the ROI, the sum of values obtained by applying weights to the pixel values included in the ROI, or a result value obtained by integrating the pixel values included in the ROI, or any combination thereof.

For example, the processor 110 may obtain a first result value output from the first Gaussian probability distribution. For example, the processor 110 may obtain a second result value output from the second Gaussian probability distribution.

For example, the processor 110 may identify a difference between the first result value output from the first Gaussian probability distribution and the second result value output from the second Gaussian probability distribution. For example, the processor 110 may identify that the external object is the target object, based on that the difference between the first result value output from the first Gaussian probability distribution and the second result value output from the second Gaussian probability distribution is greater than or equal to a first threshold.

For example, the first threshold may include a first percentage (e.g., about 70%). For example, the first threshold may include a first number. However, an embodiment of the present disclosure is not necessarily limited to those described above.

For example, the processor 110 may postpone determining the external object, based on the difference between the first result value output from the first Gaussian probability distribution and the second result value output from the second Gaussian probability distribution being less than the first threshold and being greater than or equal to a second threshold. For example, the second threshold may include a second percentage (e.g., about 40%). For example, the second threshold may include a second number that is less than the first number. However, an embodiment of the present disclosure is not necessarily limited to those described above.

For example, postponing determining the external object may include a precedence process for outputting information associated with the target object identified at a previous time point because it is unclear whether the external object is the target object at a current time point.

For example, the processor 110 may identify that the external object is not the target object, based on the difference between the first result value output from the first Gaussian probability distribution and the second result value output from the second Gaussian probability distribution being less than the second threshold.

The robot control apparatus 100 according to an embodiment may perform different operations depending on whether the external object is the target object. For example, the robot control apparatus 100 may plan a path along which the robot follows the external object, based on the external object being the target object. For example, the robot control apparatus 100 may notify the user that it fails in following the target object, based on the external object not being the target object. For example, the robot control apparatus 100 may provide the user with a guide sound indicating that it fails in following the target object, a message indicating that it fails in following the target object, or screen display indicating that it fails in following the target object, or any combination thereof, based on the external object not being the target object.

As described above, the robot control apparatus 100 according to an embodiment may identify whether the external object is the target object, using the LiDAR 120 and the camera 130, thus generating (or planning) a path for operating the robot control apparatus 100 (or the robot including the robot control apparatus 100). The processor 110 of the robot control apparatus 100 may control the robot using the generated path.

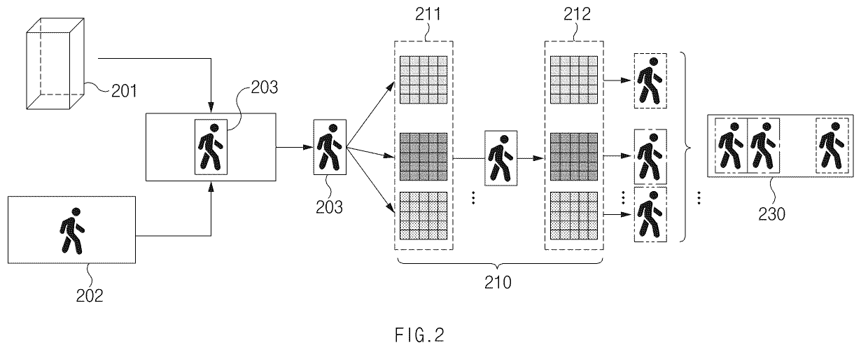

FIG. 2 illustrates an example of obtaining feature maps, in an embodiment of the present disclosure.

Referring to FIG. 2, a processor (e.g., a processor 110 of FIG. 1) of a robot control apparatus (e.g., a robot control apparatus 100 of FIG. 1) according to an embodiment may obtain three-dimensional (3D) object information 201 associated with an external object, by use of LiDAR (e.g., LiDAR 120 of FIG. 1). For example, the processor may obtain the 3D object information 201 corresponding to the external object.

In an embodiment, the processor may obtain an image 202 including a visual object corresponding to the external object by use of a camera (e.g., a camera 130 of FIG. 1). For example, the processor may project the 3D object information 201 onto a designated surface (e.g., a y-z surface). For example, the processor may identify a virtual object generated by the 3D object information 201, based on projecting the 3D object information 201 onto the designated surface. For example, the processor may identify a visual object corresponding to the virtual object generated by the 3D object information 201 in the image 202.

In an embodiment, the processor may identify a portion 203 of the image including the visual object. For example, the processor may identify the portion 203 of the image including the visual object corresponding to the virtual object generated by the 3D object information 201, based on identifying the visual object in the image 202.

For example, the processor may segment the portion 203 of the image, based on identifying the portion 203 of the image. For example, the processor may segment the portion 203 of the image to input the portion 203 of the image to a neural network model 210 stored in a memory (e.g., a memory 140 of FIG. 1).

In an embodiment, the processor may input the portion 203 of the image to the neural network model 210. For example, the processor may input the portion 203 of the image to the neural network model 210 to obtain feature maps 230 for the portion 203 of the image.

For example, the neural network model 210 may include a plurality of convolution layers 211 and 212. For example, the first layer 211 among the plurality of convolution layers 211 and 212 included in the neural network model 210 may include 20 channels with a 5×5×3 size. For example, the second layer 212 among the plurality of convolution layers 211 and 212 included in the neural network model 210 may include 25 channels with a 5×5×20 size.

In an embodiment, the processor may obtain the designated number of feature maps 230, based on inputting the portion 203 of the image to the neural network model 210 including the plurality of convolution layers 211 and 212. For example, the designated number may be identical to the number of channels of the second convolution layer 212. For example, the designated number may include about 25.

As described above, the processor of the robot control apparatus according to an embodiment may obtain the feature maps 230 for the visual object included in the portion 203 of the image, using the neural network model 210.

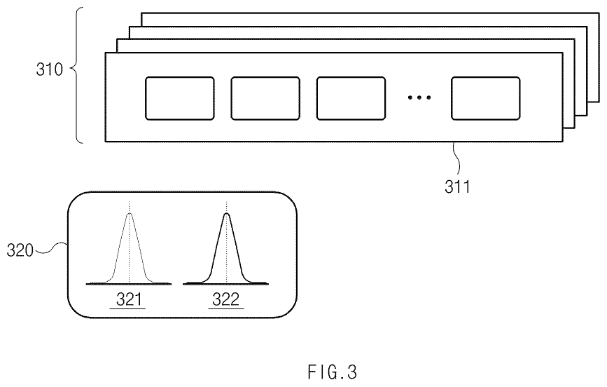

FIG. 3 illustrates an example associated with a classifier, in an embodiment of the present disclosure.

Referring to FIG. 3, a processor (e.g., a processor 110 of FIG. 1) of a robot control apparatus (e.g., a robot control apparatus 100 of FIG. 1) according to an embodiment may train a classifier group set 310 including a classifier group 311 stored in a memory (e.g., a memory 140 of FIG. 1) or may identify (or follow) a target object using the classifier group set 310.

For example, the classifier group set 310 may include the plurality of classifier groups 311. For example, the plurality of classifier groups 311 may include a plurality of classifiers. For example, the classifier group set 310 may include a machine learning algorithm. For example, the classifier group set 310 may use online boosting.

For example, the classifier group set 310 may include the n classifier groups 311. For example, each of the n classifier groups 311 may include m classifiers 320.

For example, the classifier 320 may include a first Gaussian probability distribution 321 and a second Gaussian probability distribution 322. For example, the classifier 320 may determine whether an external object is a target object, using the first Gaussian probability distribution 321 and the second Gaussian probability distribution 322.

For example, the first Gaussian probability distribution 321 may include a probability distribution for determining that the external object corresponds to the target object. For example, the second Gaussian probability distribution 322 may include a probability distribution for determining that the external object does not correspond to the target object.

For example, the processor may identify whether the external object corresponds to the target object, by using the first Gaussian probability distribution 321 and the second Gaussian probability distribution 322, based on inputting feature maps obtained from a neural network model to the classifier group set 310.

As described above, the processor of the robot control apparatus according to an embodiment may identify whether the external object corresponds to the target object, thus controlling a robot including the robot control apparatus.

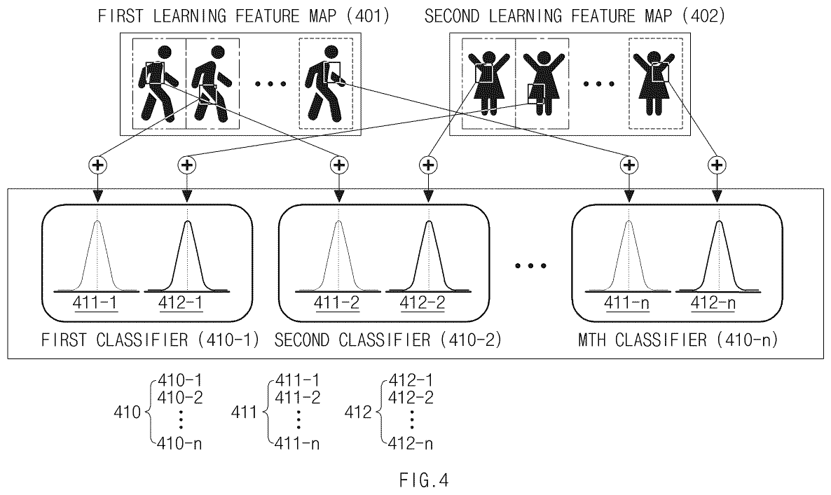

FIG. 4 illustrates an example of training a classifier, in an embodiment of the present disclosure.

Referring to FIG. 4, a processor (e.g., a processor 110 of FIG. 1) of a robot control apparatus (e.g., a robot control apparatus 100 of FIG. 1) according to an embodiment may train classifiers 410. For example, the processor may train first Gaussian probability distributions 411 and/or second Gaussian probability distributions included in the classifiers 410.

For example, the classifiers 410 may be included in the classifier group described in FIG. 3. For example, the classifiers 410 may include a first classifier 410-1, a second classifier 410-2, . . . , an Mth classifier 410-n.

For example, the processor may train the classifiers 410, using a first learning feature map 401 and a second learning feature map 402. For example, the first classifier 410-1 among the classifiers 410 may include a first Gaussian probability distribution 411-1 and a second Gaussian probability distribution 412-1. For example, the second classifier 410-2 among the classifiers 410 may include a first Gaussian probability distribution 411-2 and a second Gaussian probability distribution 412-2. For example, the Mth classifier 410-n among the classifiers 410 may include a first Gaussian probability distribution 411-n and a second Gaussian probability distribution 412-n.

For example, each of the classifiers 410 may determine whether ROIs included in a portion of an image match a target object. For example, the processor may determine whether the ROIs match the target object, using the classifiers 410.

For example, each of the first Gaussian probability distribution 411 and the second Gaussian probability distribution 412 included in each of the classifiers 410 may include a probability distribution for determining whether a designated ROI matches the target object.

For example, if input data (e.g., a learning feature map) corresponds to the target object, the processor may update the first Gaussian probability distributions 411. For example, if the input data does not correspond to the target object, the processor may update the second Gaussian probability distributions 412. For example, the first Gaussian probability distributions 411 may be referred to as a positive probability distribution. For example, the second Gaussian probability distributions 412 may be referred to as a negative probability distribution.

In an embodiment, the processor may select a classifier that is best trained as a representative classifier, based on training the classifiers 410. For example, the classifier that is best trained may be associated with whether the first Gaussian probability distribution and the second Gaussian probability distribution are clearly separated. For example, the classifier that is best trained may include a classifier in which the first Gaussian probability distribution and the second Gaussian probability distribution are clearly separated.

As described above, the processor of the robot control apparatus according to an embodiment may train the classifiers 410 to accurately determine whether an external object corresponding to a visual object included in a portion of the image is the target object.

The example of training the classifiers 410 is described in FIG. 4, but determining whether the external object corresponds to the target object, using the classifiers 410, may be substantially the same as that described above.

For example, the processor may determine whether a first ROI matches the target object, using the first classifier 410-1, and may determine whether a second ROI matches the target object, using the second classifier 410-2.

Furthermore, the processor may identify whether the external object corresponding to the visual object included in the portion of the image is the target object, based on outputs of the classifiers 410. For example, if determining that the external object is the target object based on about 70% or more of the outputs (i.e., result values) of the classifiers 410, the processor may determine the external object as the target object. For example, if determining that the external object is the target object based on about more than 40% or less than 70% of the outputs (i.e., result values) of the classifiers 410, the processor may postpone determining the external object. For example, if determining that the external object is the target object based on about less than 40% of the outputs of the classifiers 410, the processor may determine that the external object is not the target object.

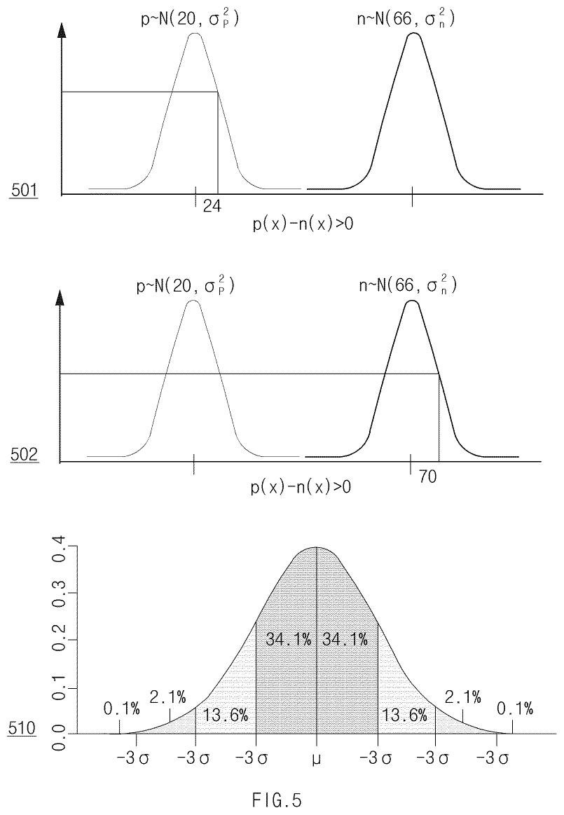

FIG. 5 illustrates an example of determining whether an external object is a target object, in an embodiment of the present disclosure.

Referring to FIG. 5, a processor (e.g., a processor 110 of FIG. 1) of a robot control apparatus (e.g., a robot control apparatus 100 of FIG. 1) according to an embodiment may perform filtering, using a standard deviation 510.

A first example 501 of FIG. 5 may include an example of representing a first Gaussian probability distribution and a second Gaussian probability distribution. In the first example 501, being represented as 24 may refer to the sum of pixel values. In the first example 501, it may be checked whether the sum of the pixel values is included in the first Gaussian probability distribution between the first Gaussian probability distribution and the second Gaussian probability distribution. For example, that the sum of the pixel values is included in the first Gaussian probability distribution between the first Gaussian probability distribution and the second Gaussian probability distribution may be identifying that an external object corresponding to a visual object included in a portion of an image is a target object.

In a second example 502 of FIG. 5, being represented as 70 may refer to the sum of pixel values. In the second example 502, it may be checked whether the sum of the pixel values is included in the second Gaussian probability distribution between the first Gaussian probability distribution and the second Gaussian probability distribution. For example, that the sum of the pixel values is included in the second Gaussian probability distribution between the first Gaussian probability distribution and the second Gaussian probability distribution may be identifying that the external object corresponding to the visual object included in the portion of the image is not the target object.

In an embodiment, the processor may determine whether the external object corresponds to the target object, using the sum of the pixel values and the standard deviation 510. For example, if the sum of the pixel values is out of a designated range of the standard deviation 510, the processor may fail to determine whether the external object corresponds to the target object using the sum of the pixel values.

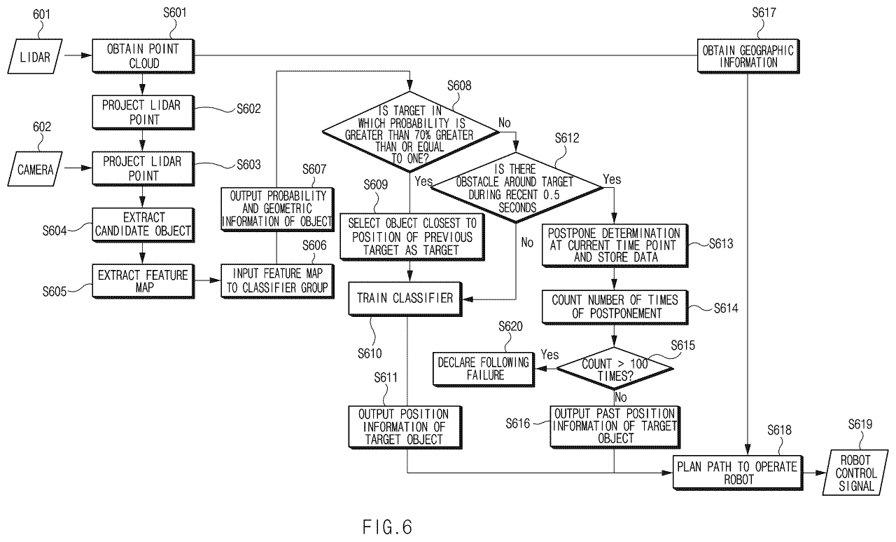

FIG. 6 illustrates an example of a flowchart associated with a robot control method according to an embodiment of the present disclosure.

A robot control apparatus 100 of FIG. 1 can perform a process of FIG. 6. Furthermore, in a description of FIG. 6, an operation described as being performed by an apparatus may be understood as being controlled by a processor 110 of the robot control apparatus 100.

At least one of the operations of FIG. 6 may be performed by the robot control apparatus 100 of FIG. 1. At least one of the operations of FIG. 6 may be controlled by the processor 110 of FIG. 1. The respective operations of FIG. 6 may be sequentially performed, but are not necessarily sequentially performed. For example, an order of the respective operations may be changed, and at least two operations may be performed in parallel.

Referring to FIG. 6, the robot control method according to an embodiment may include obtaining data associated with an external object, by use of LiDAR 601 and/or a camera 602.

In operation S601, the robot control method according to an embodiment may include obtaining a point cloud by use of the LiDAR 601. For example, the point cloud may include a set of points corresponding to an external object on a 3D virtual coordinate system.

In operation S602, the robot control method according to an embodiment may include obtaining geometric information of an object. For example, the robot control method may include obtaining the geometric information of the object, using the point cloud. For example, the geometric information may include at least one of a speed of the object, a heading direction of the object, or a size of the object, or any combination thereof.

In operation S603, the robot diagnostic method according to an embodiment may include projecting a LiDAR point. For example, the LiDAR point may be included in the point cloud. For example, the LiDAR point may include points corresponding to the external object, which are obtained by the LiDAR 601.

In operation S604, the robot control method according to an embodiment may include extracting a candidate object. For example, the robot control method may include extracting the candidate object from an image obtained by use of the camera 602. For example, the candidate object may include the external object.

In operation S605, the robot control method according to an embodiment may include extracting a feature map. For example, the robot control method may include extracting the feature map, based on inputting at least a portion of the image including the candidate object to a neural network model.

In operation S606, the robot control method according to an embodiment may include inputting the feature map to a classifier group. For example, the robot control method may include inputting the feature map output from the neural network model to the classifier group.

In operation S607, the robot control method according to an embodiment may include outputting a probability and the geometric information of the object. For example, the robot control method may include outputting a probability that a visual object corresponding to the external object will be a target object and geometric information associated with the external object, based on the feature map.

In operation S608, the vehicle control method according to an embodiment may include determining whether a target in which the probability is greater than 70% is greater than or equal to one. For example, the robot control method may include determining whether the target in which the probability that the visual object corresponding to the external object will be the target object is greater than 70% is greater than or equal to one.

If the target in which the probability is greater than 70% is greater than or equal to one (Yes in operation S608), in operation S609, the robot control method according to an embodiment may include selecting an object closest to a position of a previous target as the target.

In operation S610, the robot control method according to an embodiment may include training a classifier. For example, the robot control method may include training the classifier using the selected target, based on selecting the object closest to the position of the previous target as the target.

If the target in which the probability is greater than 70% is not greater than or equal to one (No in operation S608), in S612, the robot control method according to an embodiment may include determining whether there is an obstacle around the target during recent 0.5 seconds. It is described as the recent 0.5 seconds, but an embodiment is not limited thereto.

For example, the robot control method may perform an operation of about 10 frames (i.e., 10 times) during about 1 second. The recent 0.5 seconds may refer to about 5 frames.

If there is no obstacle around the target during the recent 0.5 seconds (No in operation S612), in operation S610, the robot control method according to an embodiment may include training the classifier.

In operation S611, the robot control method according to an embodiment may include outputting position information of the target object. For example, the robot control method may include outputting the position information of the target object in a frame obtained at a current time point.

If there is the obstacle around the target during the recent 0.5 seconds (Yes in operation S612), in operation S613, the robot control method according to an embodiment may include postponing determination at the current time point and storing data. For example, the robot control method may include failing to determine whether the visual object included in the image corresponds to the target object in the currently obtained frame.

In operation S614, the robot control method according to an embodiment may include counting the number of times of postponement. For example, the robot control method may include counting the number of times of postponing determination at the current time point.

In operation S615, the vehicle control method according to an embodiment may include determining whether the count is greater than 100 times. For example, the robot control method may include counting the number of times determination is postponed and determining whether the count is greater than 100 times.

For example, that the count is greater than 100 times may include that the target object is not identified during 100 frames.

If the count is greater than 100 times (Yes in operation S615), in operation S620, the robot control method according to an embodiment may include declaring following failure. For example, the robot control method may include declaring the following failure, based on failing in following the target object. For example, failing in following the target object may include that it is unable to identify the target object in the image.

If the count is not greater than 100 times (No in operation S615), in operation S616, the robot control method according to an embodiment may include outputting past position information of the target object.

The past in operation S616 may refer to a frame immediately before the determination is postponed.

In operation S617, the robot control method according to an embodiment may include obtaining geographic information. For example, the robot control method may include obtaining the geographic information, based on the point cloud obtained by the LiDAR 601 and/or the points. For example, the geographic information may include a map for representing a surrounding environment of a robot control apparatus (or a robot including the robot control apparatus).

In operation S618, the robot control method according to an embodiment may include planning a path to operate the robot. For example, the robot control method may include planning the path to operate the robot, based on the geographic information and/or the position information of the target object.

In operation S619, the robot control method according to an embodiment may include generating a robot control signal. For example, the robot control method may include generating a signal for operating the robot along the planned path. For example, the robot control method may include operating (or controlling) the robot, based on the generated signal.

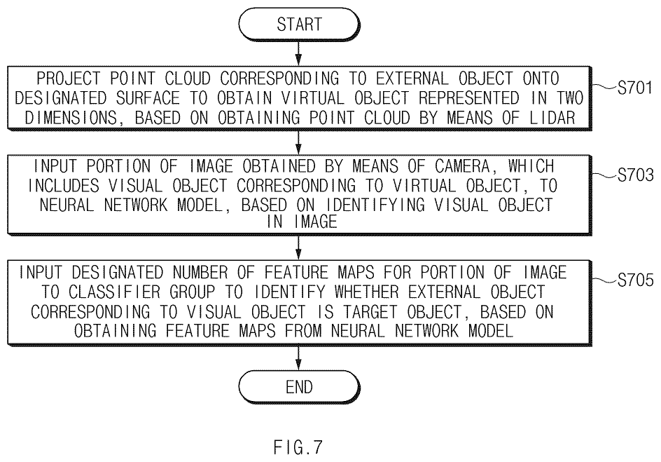

FIG. 7 illustrates an example of a flowchart associated with a robot control method according to an embodiment of the present disclosure.

A robot control apparatus 100 of FIG. 1 can perform a process of FIG. 7. Furthermore, in a description of FIG. 7, an operation described as being performed by an apparatus may be understood as being controlled by a processor 110 of the robot control apparatus 100.

At least one of the operations of FIG. 7 may be performed by the robot control apparatus 100 of FIG. 1. At least one of the operations of FIG. 7 may be controlled by the processor 110 of FIG. 1. The respective operations of FIG. 7 may be sequentially performed, but are not necessarily sequentially performed. For example, an order of the respective operations may be changed, and at least two operations may be performed in parallel.

In operation S701, the robot control method according to an embodiment may include projecting a point cloud corresponding to an external object onto a designated surface to obtain a virtual object represented in two dimensions, based on obtaining the point cloud by use of LiDAR.

In operation S703, the robot control method according to an embodiment may include inputting a portion of an image obtained by use of a camera, which includes a visual object corresponding to the virtual object, to a neural network model, based on identifying the visual object in the image.

For example, the robot control method may include obtaining feature maps, based on propagating a portion of the image to a plurality of convolution layers included in the neural network model.

In operation S705, the robot control method according to an embodiment may include inputting a designated number of feature maps for the portion of the image to a classifier group to identify whether the external object corresponding to the visual object is a target object, based on obtaining the feature maps from the neural network model.

For example, the robot control method may include identifying whether the external object is the target object, based on an ROI of each of the feature maps input to the classifier group.

For example, the robot control method may include identifying pixel values of the ROI using each of the plurality of classifiers included in the classifier group. For example, the robot control method may include identifying whether the external object is the target object, based on identifying the pixel values of the ROI using each of the plurality of classifiers.

For example, the robot control method may include identifying whether the external object is the target object, based on inputting the sum of the pixel values of the ROI to a first Gaussian probability distribution and a second Gaussian probability distribution.

For example, the robot control method may include identifying whether the external object is the target object, based on a first result value output from the first Gaussian probability distribution and a second result value output from the second Gaussian probability distribution. For example, the robot control method may include identifying whether the external object is the target object, based on the first result value obtained by use of the first Gaussian probability distribution and the second result value obtained by use of the second Gaussian probability distribution.

For example, the robot control method may include comparing a difference between the first result value and the second result value. For example, the robot control method may include identifying whether the external object is the target object, based on comparing the difference between the first result value and the second result value.

For example, the robot control method may include identifying that the external object is the target object, based on that the difference between the first result value and the second result value is greater than or equal to a first threshold.

For example, the robot control method may include postponing determining the external object, based on that the difference between the first result value and the second result value is less than the first threshold and is greater than or equal to a second threshold.

For example, the robot control method may include identifying that the external object is not the target object, based on that the difference between the first result value and the second result value is less than the second threshold.

For example, the robot control method according to an embodiment may include training the plurality of classifiers, using a first learning feature map associated with a tracking target and/or a second learning feature map associated with a general object. For example, the robot control method may include training classifiers for the first Gaussian probability distribution, using the first learning feature map associated with the tracking target. For example, the robot control method may include training classifiers for the second Gaussian probability distribution, using the second learning feature map associated with the general object.

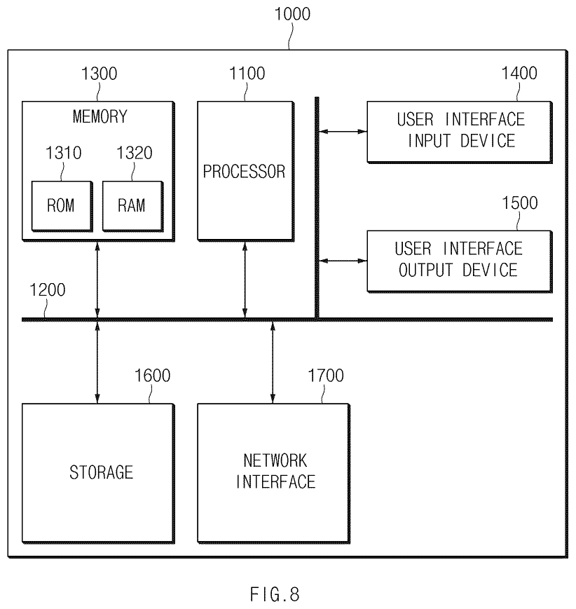

FIG. 8 illustrates a computing system associated with a robot control apparatus or a robot control method according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200, any combination of or all of which may be in plural or may include plural components thereof.

The processor 1100 may be a central processing unit (CPU) or a semiconductor device that processes instructions stored in a storage medium, such as the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the example embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

An embodiment using the present technology may identify a target object using a camera and LiDAR.

An embodiment using the present technology may identify the target object in real time to provide help to path planning of a robot.

An embodiment using the present technology may train a classifier using data obtained by the camera and the LiDAR to maintain and repair the robot at a relatively low cost.

Various advantages ascertained directly or indirectly through the present disclosure may be provided.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims.

Therefore, the example embodiments of the present disclosure are not intended to necessarily limit the technical spirit of the present disclosure, but are provided for illustrative purposes. The scopes of the present disclosure can be construed on the basis of the accompanying claims, and technical ideas within scopes equivalent to the claims can be included in the scopes of the present disclosure.

What is claimed is:

1. A robot control apparatus, comprising:
a light detection and ranging device (LiDAR);
a camera;
at least one processor; and a storage medium storing computer-readable instructions and a classifier group including a plurality of classifiers and a neural network model, that, when executed by the at least one processor, enable the at least one processor to:
project a point cloud corresponding to an external object onto a designated surface to obtain a virtual object represented in two dimensions, based on obtaining the point cloud by use of the LiDAR;
input a portion of an image obtained by use of the camera, the image including a visual object corresponding to the virtual object, to the neural network model, based on identifying the visual object in the image; and
input a designated number of feature maps for the portion of the image to the classifier group to identify whether the external object corresponding to the visual object is a target object, based on obtaining the feature maps from the neural network model.

2. The apparatus of claim 1, wherein the instructions further enable the at least one processor to identify whether the external object is the target object, based on a region of interest (ROI) of each of the feature maps input to the classifier group.

3. The apparatus of claim 2, wherein the instructions further enable the at least one processor to identify whether the external object is the target object, based on identifying pixel values of the ROI using each of the plurality of classifiers.

4. The apparatus of claim 3, wherein the instructions further enable the at least one processor to identify whether the external object is the target object, based on inputting a sum of the pixel values of the ROI to a first Gaussian probability distribution and a second Gaussian probability distribution.

5. The apparatus of claim 4, wherein the instructions further enable the at least one processor to identify whether the external object is the target object, based on a first result value output from the first Gaussian probability distribution and a second result value output from the second Gaussian probability distribution.

6. The apparatus of claim 4, wherein the instructions further enable the at least one processor to identify that the external object is the target object, based on a difference between a first result value output from the first Gaussian probability distribution and a second result value output from the second Gaussian probability distribution being greater than or equal to a first threshold.

7. The apparatus of claim 4, wherein the instructions further enable the at least one processor to postpone determining the external object, based on a difference between a first result value output from the first Gaussian probability distribution and a second result value output from the second Gaussian probability distribution being less than a first threshold and being greater than or equal to a second threshold, wherein the second threshold is smaller than the first threshold.

8. The apparatus of claim 4, wherein the instructions further enable the at least one processor to identify that the external object is not the target object, based on a difference between a first result value output from the first Gaussian probability distribution and a second result value output from the second Gaussian probability distribution being less than a second threshold, wherein the second threshold is smaller than a first threshold.

9. The apparatus of claim 1, wherein the instructions further enable the at least one processor to train the plurality of classifiers, using a first learning feature map associated with a tracking target and a second learning feature map associated with associated with a general object.

10. The apparatus of claim 1, wherein the instructions further enable the at least one processor to obtain the feature maps, based on propagating the portion of the image to a plurality of convolution layers included in the neural network model.

11. The apparatus of claim 1, wherein the instructions further enable the at least one processor to initialize at least one of partial classifiers except for a representative classifier among the plurality of classifiers, based on selecting the representative classifier.

12. The apparatus of claim 1, wherein the instructions further enable the at least one processor to assign a region of interest (ROI), based on at least one of the feature maps, while initializing at least one of the plurality of classifiers.

13. A robot control method, comprising:
obtaining a point cloud corresponding to an external object within a vicinity of a robot, by use of a light detection and ranging device (LiDAR) of the robot;
projecting the point cloud corresponding to the external object onto a designated surface within the vicinity of the robot to obtain a virtual object represented in two dimensions based on the point cloud corresponding to the external object;
obtaining an image by use of a camera of the robot, the image including a visual object corresponding to the virtual object;
inputting a portion of the image to a neural network model;
obtaining feature maps for the portion of the image from the neural network model; and
inputting a designated number of the feature maps for the portion of the image to a classifier group to identify whether the external object corresponding to the visual object is a target object.

14. The method of claim 13, further comprising identifying whether the external object is the target object, based on a region of interest (ROI) of each of the feature maps input to the classifier group.

15. The method of claim 14, further comprising identifying whether the external object is the target object, based on identifying pixel values of the ROI using each of a plurality of classifiers included in the classifier group.

16. The method of claim 15, further comprising identifying whether the external object is the target object, based on inputting a sum of the pixel values of the ROI to a first Gaussian probability distribution and a second Gaussian probability distribution.

17. The method of claim 16, further comprising identifying whether the external object is the target object, based on a first result value output from the first Gaussian probability distribution and a second result value output from the second Gaussian probability distribution.

18. The method of claim 16, further comprising identifying that the external object is the target object, based on a difference between a first result value output from the first Gaussian probability distribution and a second result value output from the second Gaussian probability distribution being greater than or equal to a first threshold.

19. The method of claim 16, further comprising postponing determining whether the external object is the target object, based on a difference between a first result value output from the first Gaussian probability distribution and a second result value output from the second Gaussian probability distribution being less than a first threshold and being greater than or equal to a second threshold, wherein the second threshold is smaller than the first threshold.

20. The method of claim 16, further comprising identifying that the external object is not the target object, based on a difference between a first result value output from the first Gaussian probability distribution and a second result value output from the second Gaussian probability distribution being less than a second threshold, wherein the second threshold is smaller than a first threshold.

21. The method of claim 13, further comprising training a plurality of classifiers included in the classifier group, using a first learning feature map associated with a tracking target and a second learning feature map associated with associated with a general object.

22. The method of claim 13, further comprising obtaining the feature maps, based on propagating the portion of the image to a plurality of convolution layers included in the neural network model.
